(19) United States
(12) Patent Application Publication
(10) Pub. No.: US 2012/0230806 A1
(43) Pub. Date: Sep. 13, 2012

(54) Hearing aid battery handler

(76) Inventor: Donald Rumpel, Smelterville, ID (US)

(21) Appl. No.: 13/385,804

(22) Filed: Mar. 7, 2012

Related U.S. Application Data
(60) Provisional application No. 61/464,779, filed on Mar. 9, 2011.

(51) Int. Cl. B25J 1/00; B25J 15/06

(52) U.S. Cl. 414/800; 294/65.5

(57) ABSTRACT

An apparatus, kit or methods for improved handling of hearing aid batteries. The apparatus has a handle with a handle portion grasped by a user and a first end portion over which a nose piece is connected to capture at least one magnet therebetween. The nose piece which is preferably of a plastic contacts the hearing aid battery and provides a modified magnetic flux and easily slidable surface for easier handling of the hearing aid battery. The nose piece can be provided with apertures to adjust the magnetic flux applied to the hearing aid battery. The kit includes the apparatus therein and can also include extra batteries.

### CROSS REFERENCE TO RELATED APPLICATIONS

This application claims priority to U.S. Provisional Patent Application Ser. No. 61/464,779, filed Mar. 9, 2011, which is hereby incorporated by reference herein in its entirety.

### TECHNICAL FIELD

The disclosures provided herein relate to facilitating use and handling of hearing aid batteries and the like.

### BACKGROUND DISCUSSION

Hearing aid batteries are relatively small, usually cylindrical batteries often less than one-half inch (12 mm) in diameter. They typically are about 50-80% as tall as the diameter. However, many various sizes and proportions have been used in the past. It is expected a large number of variation will also be used in future batteries.

The relatively small size of hearing aid batteries makes them very hard to handle, especially for people with large fingers. Thus, the batteries are often dropped or just inconvenient to handle. If dropped, then they are hard to find and difficult to pick up from the floor or other surface upon which they are resting.

In many cases men who have large hands and fingers are especially troubled by the handling of hearing aid batteries and may ask others for help who have smaller hands and fingers. Thus, the hearing aid wearer must trouble another person for help. If the hearing aid user with large fingers and hands, or with an infirmity, lives alone, then there is no one at home to help and the task becomes a routine difficulty.

Current trends in the design,of hearing aids is to provide for smaller hearing aids over prior art units. As a general rule, the smaller the hearing aid itself, the smaller will be the hearing aid battery. Thus, hearing aid batteries are becoming ever smaller, and consequently ever more difficult to handle (i.e., to place in the hearing aid itself). Further, from a demographic standpoint, hearing aid users tend to be persons who are more advanced in years, and thus may suffer from arthritis, Parkinson's disease, loss of near sight vision, and other afflictions which can affect their ability to manipulate a very small hearing aid battery into a hearing aid.

Also, in many cases a hearing aid user likes to go out visiting, shopping, for entertainment and other activities. Thus, if a hearing aid user wishes to guard against the loss of use of his/her hearing aid during such excursions due to a hearing aid battery failure, the user must carry a spare battery. As can be appreciated, due to the small size of a hearing aid battery, any means for conveyance of such a battery can be rife with problems. For example, if two batteries are conveyed together in a resealable plastic pouch (as would be desirable for a user having two hearing aids), then the two batteries may come into contact with one another in such a manner as to degrade one or both batteries (e.g., if the positive poles of both batteries were to come into contact with one another). Further, when a hearing aid user is on an excursion outside of the home, there may be no one presents to assist the user in placing the battery into the hearing aid if the user is unable to do so on their own (e.g., for reasons discussed above).

For all users, and particularly those who have eyesight impairment, having the hearing air batteries in a constantly convenient carrying location is also an advantage.

The identification of problems, deficiencies, potential or actual benefits or advantages described above are not admitted to be prior art.

### BRIEF DESCRIPTION OF THE DRAWINGS

Preferred forms, configurations, embodiments and/or diagrams relating to and helping to describe preferred aspects and versions of the inventions provided for herein are explained and characterized herein, often with reference to the accompanying drawings. The drawings, and all features shown therein, also serve as part of the disclosure of the inventions encompassed within the current document, whether described in text or merely by graphical disclosure alone. Such drawings are briefly described below.

FIG. 1 is a side view of one embodiment of an apparatus provided for by the present disclosure.

FIG. 2 is a top view of the apparatus of FIG. 1.

FIG. 3 is a bottom view of the apparatus of FIG. 1.

FIG. 4 is a diagrammatic view of a portion of the apparatus depicted in FIG. 1, showing the apparatus as-used to support a hearing aid battery.

FIG. 5 is a side sectional view of a first internal configuration of the apparatus of FIG. 1.

FIG. 6 is a side sectional view of a second (and alterative to FIG. 5) internal configuration of the apparatus of FIG. 1.

FIG. 7 is a side sectional view of a third (and alternative to FIGS. 5 and 6) internal configuration of the apparatus of FIG. 1.

FIG. 8 is a side sectional view of a fourth embodiment of an apparatus provided for by the present disclosure.

FIG. 9 is a side view of a kit assembly according to another embodiment, including a magnetic pick-up tool within a carrying case.

FIG. 10 is a cutaway view of a container top wherein a pair of batteries are stored in juxtaposition, as can be used in the kit depicted in FIG. 9.

FIG. 11 is side view of the container, or carrying case, portion of the kit assembly depicted in FIG. 9.

### DETAILED DESCRIPTION

### Introductory Notes

The readers of this document should understand that the embodiments described herein may rely on terminology used in any section of this document and other terms readily apparent from the drawings and the language common therefor as may be known in a particular art, and such as known or indicated and provided by dictionaries. Dictionaries were used in the preparation of this document. Widely known and used in the preparation hereof are Webster's Third New International Dictionary (©1993), The Oxford English Dictionary (Second Edition, ©1989), and The New Century Dictionary (©2001-2005), all of which are hereby referenced for interpretation of terms used herein and for application and use of words defined in such references to more adequately or aptly describe various features, aspects and concepts shown or otherwise described herein using more appropriate words having meanings applicable to such features, aspects and concepts which are depicted or otherwise disclosed herein.

This document is premised upon using one or more terms with one embodiment that may also apply to other embodiments for similar structures, functions, features and aspects of the inventions. Wording used in the claims is also descriptive of the inventions, and the text and meaning of the claims and abstract are hereby incorporated by reference into the description in their entirety as originally filed. Terminology used with one, some or all embodiments may be used for describing and defining the technology and exclusive rights associated herewith.

The readers of this document should further understand that the embodiments described herein may rely on terminology and features used in any suitable section or other embodiments shown in this document and other terms readily apparent from the drawings and language common or proper therefor. This document is premised upon using one or more terms or features shown in one embodiment that may also apply to or be combined with other embodiments for similar structures, functions, features and aspects of the inventions and provide additional embodiments of the inventions.

The invention(s) provided for by this disclosure may include a number of different specific configurations, embodiments, and/or variations, some or all having different advantages or effects relative to features, operation and production.

Features shown on some of the illustrated and/or described versions may also be used on other embodiments if aspects of construction and use do not prevent such added configurations from being implemented according to this disclosure.

### General Features/Elements

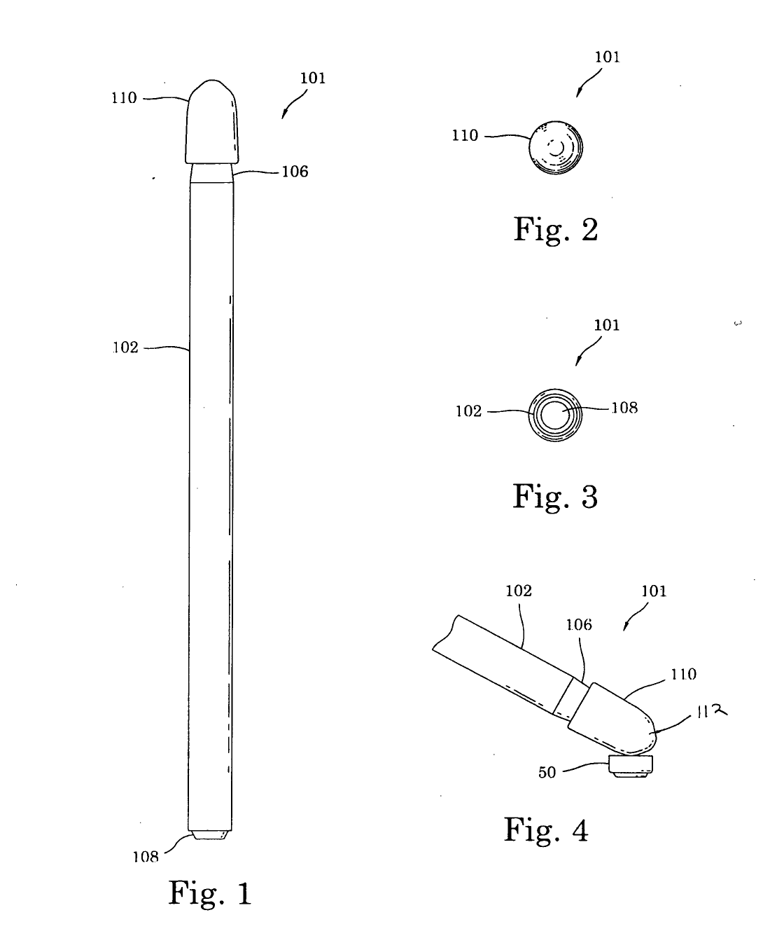

FIG. 1 is a side (or elevational) view of an apparatus 101 in which several general features and/or elements are shown according to several embodiments of the present disclosure. The generally intended use of the apparatus 101 is to assist a user in the manipulation and/or handling of small hearing aid batteries by way of magnetism, or magnetic force, as is described in further detail hereinbelow. The hearing aid tool apparatus 101 has a handle portion 102. The handle 102 has a first end 106 and an opposite and distal second end 108. The second end 108 can include, or can be substantially in the form of a plug as illustratively depicted. The handle 102 can be substantially elongate as shown. (In alternative configurations, the handle 102 can be curved, and particularly to provide ergonomic benefits to the user.) According to the exemplary embodiment of the disclosure as depicted in FIG. 1, the handle portion 102 is substantially straight and elongate. The handle 102 of the apparatus 101 is fabricated from a suitable material such as a polymer. For example, the handle 102 can be made of a suitable ABS polymer, although other suitable alternative materials can be employed in fabricating the handle 102. The handle 102 can have one or more of a number of colors allowing the apparatus to be more easily identified and/or located by a user. Additionally, the handle 102 can have applied thereon one or more types of graphics including, but not limited to, instructions, warnings, reflective coatings, identification markings, and the like. The handle 102 can also be provided with indents, grooves or other surface features to facilitate gripping of the handle by a user.

The handle portion 102 of the apparatus 101 is adapted to be grasped by a user thereof. The apparatus 101 can be generally the size and shape of a typical disposable ink pen or a pencil according to the exemplary embodiment of the apparatus. According to one intended use of the apparatus 101, the handle portion 102 can be grasped in a manner similar to that in which a typical ink pen or pencil is grasped by a user when used for writing. More specifically, the apparatus 101 can be grasped in such a manner, wherein the relative position of the first end 106 corresponds generally with that of the tip of an ink pen or pencil point when such a pen or pencil is used for writing. While the accompanying drawings depict embodiments wherein respective handles are of a straight, elongate form, it should be appreciated that other forms of the handle can be alternatively employed within the scope of the present disclosure. For example, in one such variation, the handle 101 (or equivalent thereof) can be curved, while in another variation, the handle can be in the form (and shape) of a body configured for ease of grasping by a user, such as, for example, a pistol grip.

The apparatus 101 can include a nose piece 110. The nose piece 110 can be installed at the first end 106 of the apparatus 101 as shown. In accordance with the exemplary embodiment of the disclosure depicted in FIG. 1, the nose piece 110 can be substantially in the form of a cap that fits over at least a portion of the first end 106. The nose piece 110 can be attached to the handle portion 102. For example, the nose piece 110 can be securely attached or adhered using one of a number of suitable attachment means. Suitable means of attaching the nose piece 110 to the handle can include, but are not limited to, a snap fit, an interference fit, threading, fastening, and bonding. Bonding can include, but is not limited to using an adhesive bonding agent, using heat/thermal bonding or welding, and by using sonic bonding or welding. As exemplified by the depiction of the apparatus 101 in FIG. 1, the nose piece 110 can have a substantially dome-like configuration. However, alternative shapes and/or configurations of the nose piece 110, which are not specifically shown or described herein, are within the intended scope of the disclosure.

The nose piece 110 can be fabricated from a material that is magnetically permeable. More specifically, the nose piece 110 can be fabricated from a material that allows magnetic flux to pass therethrough. According one or more embodiments of the present disclosure, the nose piece 110 is made of a material that is a suitable polymer. For example, the nose piece 110 can be made of a suitable polymer such as, but not limited to, a polyvinyl polymer and an ABS polymer. Other suitable materials are within the intended scope of the disclosure. According to at least one embodiment of the present disclosure, the nose piece 110 is perforated to aide in enabling magnetic flux to pass through the nose piece. For example, the nose piece 110 can be provided with apertures (not shown) therein to allow magnetic flux therethrough. The nose piece 110 can have one or more of a number of possible colors. For example, the nose piece 110 can have be of a color that contrasts with, or complements, a color of the handle 102, or of one or more types of graphics borne by the handle. It is to be understood that the nose piece 110 can be omitted according to alternative embodiments of the apparatus 101, which are not specifically depicted or described herein. For example, according to at least one such variation, an integral rounded nose end of the handle can replace the nose piece 110.

With reference now to FIG. 2, a top view of the apparatus 101 shows the nose piece 110. Similarly, with reference to FIG. 3, a bottom view of the apparatus 101 shows the handle 102 and the second end 108 thereof. With reference to FIGS. 2 and 3, it is seen that the apparatus 101 can have a substantially round cross-section. More specifically, it is seen that the nose piece 110, the handle 102 and the second end 108 can each have substantially round cross-sectional shapes. Alternative cross-sectional shapes of one or more of the nose piece 110, the handle 102 and the second end 108 can include, but are not limited to, multi-lobed shapes, and multi-faceted shapes such as octagons, hexagons, pentagons, rectangles and triangles. Furthermore, still other shapes, which are not specifically described or depicted herein, are within the contemplated scope of the present disclosure.

Turning now to FIG. 4, a diagrammatic view shows the first end 106 of the handle portion 102 of the apparatus 101, along with the nose piece 110 and a typical hearing aid battery 50. Also depicted in FIG. 4 is a contact area 112. The contact area 112 can be defined on the nose piece 110 as shown. The exemplary contact area 112 is less curved in longitudinal section than is the tip (not numberered) of the nose piece 110, and can be useful in some maneuvers, such as that shown in FIG. 4. The type of maneuvering depicted in FIG. 4 can allow the battery 50 to more easily be slid relative to the nose piece 110 such as when placing the battery into a receptacle or other final resting place in a hearing aid (not shown) or onto a table or other location for testing of charge or for other reasons. More specifically, the contact area 112 can be adapted for engagement with the battery 50 at a desired orientation when the battery is attracted to the nose piece 110 by way of magnetism or magnetic flux, as is described in further detail hereinbelow.

The apparatus 101 can have one of several internal configurations. Several exemplary internal configurational embodiments are described herein below with reference to respective drawing figures, as noted. It is to be understood that the outer appearance of each of the alternative internal configurations can be substantially identical to that of the exemplary apparatus 101 as depicted in FIGS. 1-4. That is, each of the exemplary internal configurational embodiments described hereinbelow can have an external appearance which is substantially identical to that of the apparatus 101 of FIGS. 1-4. It is to be further understood that, except as specifically noted, the components of each of the alternative configurations described hereinbelow can be substantially identical to the comparable and/or corresponding components and/or elements of the exemplary apparatus 101, which is described above with reference to FIGS. 1-4. It is to be further understood that individual features, characteristics, and/or elements described hereinbelow with respect to the exemplary internal configurational embodiments can be selectively combined to the extent possible in order to form a further alternative internal configuration that is not specifically depicted or described herein.

### First Configuration

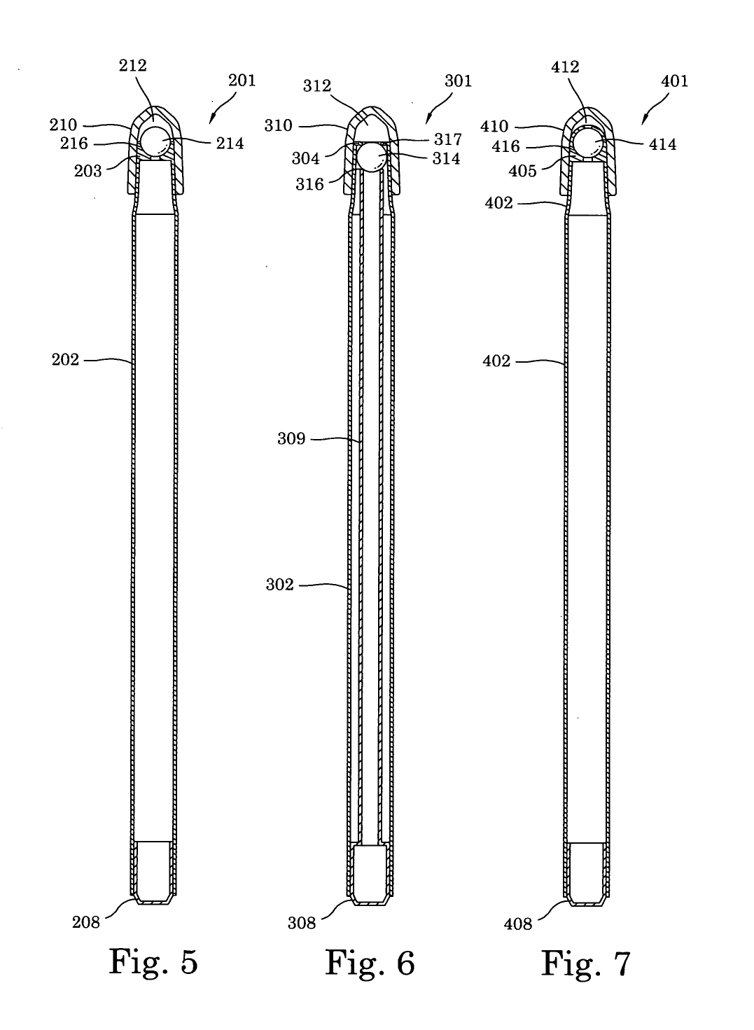

A first configuration according to at least one embodiment of the disclosure is shown with reference to FIG. 5, which is a side (elevational) sectional view of an apparatus 201. With the exception of certain features and/or elements specifically described herein below, the apparatus 201 and/or components thereof can be substantially similar to the apparatus 101 and/or respective corresponding components thereof, which are described herein above with respect to FIGS. 1-4. As is seen with reference to FIG. 5, the handle 202 can be substantially in the form of a hollow tube. The second end 208 of the apparatus 201 can be in the form of a plug that is fitted into one end of the substantially tubular handle 202. The second end 208 can be affixed to the handle 202 in one or more of a number of manners. For example, the second end 208 can have a slip fit or a press fit into the handle 202. As further example, the second end 208 can be bonded, fastened, or threaded to the handle 202 by one or more bonding means discussed herein, or by other means now known or henceforth discovered.

The apparatus 201 can include an end portion 203 that is opposite and distal from the second end 208. The end portion 203 can be substantially integral with the handle 202, as is depicted in FIG. 5. Alternatively, the end portion 203 can be a separate component that is affixed and/or fitted to the handle 202 according to one or more embodiments of the disclosure, which are not specifically depicted herein. The apparatus 201 can include a saddle or socket 216. The saddle or socket 216 can be defined by, or formed into, the end portion 203, as depicted. The saddle 216 can have one of a number of shapes and/or configurations. According to the exemplary embodiment of the disclosure depicted in FIG. 5, the saddle 216 has a substantially concave hemispherical shape. It is to be understood that alternative shapes and/or configurations of the saddle 216 are within the intended scope of the present disclosure, but are not specifically described and/or depicted herein.

The apparatus 201 includes a magnet 214. The magnet 214 is intended to provide a magnetic force or magnetic flux for at least the purposes described herein above with respect to FIGS. 1-4. The magnet 214 can be supported by or attached to the handle 202. According to the exemplary embodiment of the disclosure depicted in FIG. 5, the magnet 214 is supported on the end portion 203. More specifically, the magnet 214 is substantially nested, or cradled, within the saddle 216. The magnet 214 can be held in place within the saddle 216 and/or to the end portion 203 by one or more of several means. For example, the magnet 214 can be bonded to the end portion 203 using a suitable bonding agent (not shown) or other means. As a further example, the magnet 214 can be captured within the saddle 216 by way of a “snap-fit” whereby an outer portion of the saddle is made to be slightly smaller dimensionally, than the magnet. In this manner, the magnet 214 can be forcefully inserted into the saddle 216, during which insertion a dimensionally smaller outer end portion of the saddle is temporarily expandably deformed by forceful engagement with the magnet, to allow the magnet to pass therethrough and be seated in place within the saddle. In one variation, the magnet 214 is free to float between the saddle 216 and the inside surface of the nose piece 210 (described below).

The magnet 214 can have one of a number of configurations and/or shapes. According to at least one embodiment of the present disclosure, the magnet 214 is substantially spherical in shape. More specifically, for example, the magnet 214 can be 3/16 inch nominal diameter, spherical, neodymium, grade N42—nickel plated, and axially magnetized. Such a magnet is readily available from a number of sources including, for example, as part number S3 from K&J Magnetics, Inc., 2110 Ashton Drive, Suite 1A, Jamison, Pa. 18929. It is to be understood that other shapes and/or configurations of the magnet 214, which are not specifically described or depicted herein, are within the intended scope of the present disclosure. According to the exemplary embodiment of the present disclosure, the magnet can be selected so that a magnetically attractable object, (such as a battery) having a weight of less than about between 1.10 ounces and 1.13 ounces, can be suspended against the force of gravity from the apparatus 201 according to the intended use thereof. Moreover, the magnet 214 is preferably selected to have sufficient magnetic strength to enable the apparatus 201 to pick up and hold against gravity, by way of such magnetic strength, any battery intended for use in a hearing aid when the apparatus 201 (or any variant thereof) is used as described and/or depicted herein. Further, the magnet 214 is preferably selected to have sufficiently limited magnetic strength to allow such a hearing aid battery held by the apparatus 210 to be easily wiped off or removed therefrom and into a battery receptical of a hearing aid. Thus, the device disclosed and described herein, when used as intended, differs from prior art magnetic pick up devices (such as, for example, magnetic pick up devices for picking up and holding threaded fasteners and the like) in that the device of the present disclosure allows a hearing aid battery (held by the device) to be removed from the device without requiring the user to grasp the battery and pull it free from the device.

Still referring to FIG. 5, the apparatus 201 includes a nose piece 210, which can be substantially similar to the nose piece 110 described herein above with respect to FIGS. 1-4. As is seen from a study of FIG. 5, the nose piece 210 is fitted to the handle 202 in a manner such that the magnet 214 is substantially covered by, or contained within, the nose piece. With continued reference to FIG. 5, it is seen that a head space or clearance 212 is defined between the magnet 214 and the nose piece 210. Generally, a level of magnetic attraction between a given magnet and a given magnetically attractable object is inversely proportional to the distance between the magnet and the object. Thus, the amount of head space 212 can be predetermined in accordance with a desired level of magnetic force by which a magnetically attractable object impinges upon the nose piece 210. For example, an increased amount of head space 212 can result in a decreased level of magnetic force by which a given object impinges upon the nose piece 210, which impingement is illustrated by the exemplary depiction shown in FIG. 4. According to at least one embodiment of the present disclosure, the magnet 214 is not firmly or rigidly attached to either of the handle 202 or the nose piece 210. According to such a variation, the magnet 214 is captured, or trapped, between the nose piece 210 and the handle 202, and is allowed to move within the headspace 212.

As can be appreciated from FIG. 4, in one variation the nose piece 110 has at least one contact area adapted for engaging with a hearing aid battery 50 at a desired orientation when such a battery is attracted to the nose piece by the magnet 214 (FIG. 5). More specifically, the nose piece 110 (210, FIG. 5) is defined by an exposed end (not numbered, but depicted as the uppermost part of nose piece 210 in FIG. 5) and a side portion (again, not numbered, but located below the exposed end and the area of attachment to handle 202, FIG. 5), and the magnet 214 is positioned beneath the nose piece 210 such that the hearing aid battery (50, FIG. 4) attaches to the nose piece 110, 210 in an area defined between the exposed end and the side portion of the nose piece. In this way the battery 50 can be held by the apparatus 101, 201 in an essentially horizontal position while the handle 102, 202 is at an angle of between approximately thirty (30) degrees and sixty (60) degrees (and more preferably, around 40-50 degrees) from the horizontal. This facilitates placement of the battery 50 into a battery receptacle in a hearing aid. More specifically, the void-space 212 (FIG. 5) between the exposed end of the nose piece 210 can assist in preventing the battery 50 from attaching to the nose piece 210 at the exposed end of the nose piece. The thickness of the nose piece 110, 210 can also be varied such that the nose piece is thicker at the exposed end than at the side portions, thus attenuating magnetic attraction such that the battery 50 preferentially attaches to the nose piece in a region between the exposed end and the side portion of the nose piece.

In yet another variation, the handle 102 of the apparatus 101 can be configured in a shape (such as a serrated or grooved shape) to facilitate the user in distiguishing the apparatus from a ball point pen or other apparatus. Further to this end, the overall length of the apparatus 101 can be limited to a length of approximately 5 inches or less to further faciliate a user in distiguishing the apparatus from a ball point pen or other apparatus.

### Second Configuration

A second configuration according to at least one embodiment of the disclosure is shown with reference to FIG. 6, which is a side elevational sectional view of an apparatus 301. With the exception of certain features and/or elements specifically described herein below, the apparatus 301 and/or components thereof can be substantially similar to the apparatus 101 and/or respective corresponding components thereof, which are described herein above with respect to FIGS. 1-4. As is seen with reference to FIG. 6, the handle 302 can be substantially in the form of a hollow tube. The second end 308 of the apparatus 301 can be in the form of a plug that is fitted into one end of the substantially tubular handle 302. The second end 308 can be affixed to the handle 302 in one or more of a number of manners. For example, the second end 308 can have a slip fit or a press fit into the handle 302. As further example, the second end 308 can be bonded, fastened, or threaded to the handle 302. The apparatus 301 also includes a nose piece 310, which can be substantially identical to the nose pieces 110, 210 described above with respect to FIGS. 1-4 and 5, respectively.

The apparatus 302 includes a magnet 314, which can be substantially identical to the magnet 214 described hereinabove with respect to FIG. 5. A headspace or clearance 312 can be defined substantially between the magnet 314 and the nose piece 310. The headspace 312 can be predetermined, and can function in a manner substantially identical with that of the headspace 212 described above with respect to FIG. 5. With reference to FIG. 6, the apparatus 301 also includes a stop 304 that is opposite and distal from the second end 308. The stop 304 can be substantially integral with the handle 302, as is depicted in FIG. 6. Alternatively, the stop 304 can be a separate component that is affixed and/or fitted to the handle 302 according to one or more embodiments of the disclosure, which are not specifically depicted herein. An aperture 317 can be defined through the stop 304. Both the stop 304 and the aperture 317 can each have a circular shape to thereby lend an annular or ring-like appearance to the stop. It is to be understood that alternative shapes and/or configurations of the stop 304 and/or of the aperture 317 are within the intended scope of the present disclosure, but are not specifically described and/or depicted herein.

The apparatus 301 includes a keeper 309. The keeper 309 can be in the form of an elongated stem or rod. According to the exemplary embodiment of the disclosure depicted in FIG. 6, the keeper 309 is substantially in the form of an elongated hollow tube that is adapted to fit within the handle 302, as shown. The keeper 309 is adapted to have a substantially snug fit between the magnet 314 and the second end 308 to thereby trap the magnet between the keeper and the stop 304 as is seen from a study of FIG. 6. By virtue of being substantially in the form of a hollow tube, an end of the keeper 309 is adapted to substantially center itself upon the spherical magnet 314 when in contact therewith as shown. According to the exemplary embodiment of the disclosure, the keeper 309 is integral with the second end portion 308, as is seen from a careful examination of FIG. 6. More specifically, the second end portion 308 can be substantially in the form of a plug that is fittable within the handle 302, while the keeper 309 is integral with, and extends from, the second end portion. According to at least one alternative embodiment of the disclosure, not depicted herein, the keeper 309 is a separate component which is not integral with the second end 308. Still referring to FIG. 6, an assembly process of the apparatus 301 includes first placing the magnet 314 into the handle 302, after which the keeper 309 is inserted into the handle, followed by insertion therein of the second end portion 308, and finally securement of the second end to the handle.

### Third Configuration

A third configuration according to at least one embodiment of the disclosure is shown with reference to FIG. 7, which is a side (elevational) sectional view of an apparatus 401. With the exception of certain features and/or elements specifically described herein below, the apparatus 401 and/or components thereof can be substantially similar to the apparatus 101 and/or respective corresponding components thereof, which are described herein above with respect to FIGS. 1-4. Furthermore, the apparatus 401 can be substantially identical to the apparatus 201 (depicted in FIG. 5), with the exception of the configuration of the end portion 203 and the saddle 216 (FIG. 5), as described hereinbelow.

As is seen with reference to FIG. 7, the handle 402 can be substantially in the form of a hollow tube. The second end 408 of the apparatus 401 can be in the form of a plug that is fitted into one end of the substantially tubular handle 402. The second end 408 can be affixed to the handle 402 in one or more of a number of manners. For example, the second end 408 can have a slip fit or a press fit into the handle 402. As further example, the second end 408 can be bonded, fastened, or threaded to the handle 402. The apparatus 401 also includes a nose piece 410, which can be substantially identical to the nose pieces 110, 210 described above with respect to FIGS. 1-4 and 5, respectively.

The apparatus 401 can include an end portion 405 that is opposite and distal from the second end 408. The end portion 405 can be substantially integral with the handle 402, as is depicted in FIG. 7. Alternatively, the end portion 405 can be a separate component that is affixed and/or fitted to the handle 402 according to one or more embodiments of the disclosure, which are not specifically depicted herein. The apparatus 401 can include a saddle or socket 416. The saddle or socket 416 can be defined by the end portion 405, as depicted. The saddle 416 can have one of a number of shapes and/or configurations. According to the exemplary embodiment of the disclosure depicted in FIG. 7, the saddle 416 is substantially a spherical chamber defined within the end portion 405. It is to be understood that alternative shapes and/or configurations of the saddle 416 are within the intended scope of the present disclosure, but are not specifically described and/or depicted herein.

The apparatus 401 includes a magnet 414, which can be substantially identical to the magnet 214 described hereinabove with respect to FIG. 5. A headspace or clearance 412 can be defined substantially between the magnet 414 and the nose piece 410, or between the magnet and the end portion 416. The headspace 412 can be predetermined, and can function in a manner substantially identical to that of the headspace 212 described above with respect to FIG. 5. As is seen from a study of FIG. 7, the magnet 414 can be substantially surrounded by the end portion 405. According to the exemplary embodiment of the disclosure depicted in FIG. 7, the magnet 414 is substantially molded into the end portion 405. Alternatively, the end portion 405 can consist of two sections, wherein a first section is configured substantially identical to the end portion 203 of the apparatus 201 described above with respect to FIG. 5. In such an alternative configuration, a second section is configured generally in the manner of a cap which is matingly bonded or otherwise attached to the first section to capture there within the magnet 414 so as to appear substantially as the end portion 405 is depicted in FIG. 7. In yet a further variation, the the end portion 405 can be formed by two generally mirrored components (mirrored along the vertical plane of FIG. 7) between which the magnet 414 can be captured, and the two mirrored compound can be joined to one another by means such as gluing, bonding, snap-fit, or other known means for joining mating components. It should be appreciated that, according to one or more alternative embodiments of the disclosure, the nose piece 410 can by omitted and/or can be replaced by the end portion 405. For example, according to at least one such alternative variation of the apparatus 401, the nose piece 410 is omitted, and the end portion 405 is selected to have sufficient thickness to enable to device to function as intended. More specifically, the end portion 405 can be selected to have a thickness which affects (such as by limiting) the magnetic force with which a magnetically attractable object impinges thereagainst when the device is used as described herein.

### Fourth Configuration

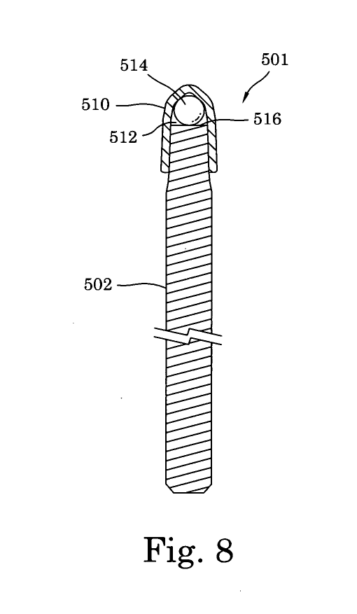

A fourth configuration according to at least one embodiment of the disclosure is shown with reference to FIG. 8, which is a longitudinal sectional (side) view of an apparatus 501. With the exception of certain features and/or elements specifically described herein below, the apparatus 501 and/or components thereof can be substantially similar to the apparatus 101 and/or respective corresponding components thereof, which are described herein above with respect to FIGS. 1-4. Furthermore, the apparatus 501 can be substantially similar to the apparatus 201 described hereinabove with respect to FIG. 5, subject to the exceptions specifically described hereinbelow.

The apparatus 501 includes a handle 502. The handle 502 can be substantially solid, as shown. An end surface 516 is defined on the handle 502. The end surface 516 is substantially flat according to the exemplary embodiment of the disclosure depicted in FIG. 8. However, it is to be understood that the end surface 516 can have any of a number of alternative shapes and/or contours according to the intended scope of the present disclosure. The apparatus 501 includes a magnet 514, which can be substantially identical, in configuration and/or function, to the magnet 214 described hereinabove with respect to FIG. 5. The apparatus 501 includes a nose piece 510 that can be substantially identical to the nose pieces 110, 210 described hereinabove with respect to FIGS. 1-4 and FIG. 5 respectively. Furthermore, the nose piece 510 can be attached to the handle 502 in manners described hereinabove in regard to attachment of nose pieces (e.g., 210, 310, 410) to respective handles (302, 302, 402).

With continued reference to FIG. 8, the magnet 514 can be substantially contained within the nose piece 510. More specifically, the magnet 514 can be substantially captured between the nose piece 510 and the end surface 516 of the handle 502. According to one embodiment of the present disclosure, the magnet 514 is bonded to the end surface 516 by way of a bonding agent 512. According to an alternative embodiment of the present disclosure, the magnet 514 is bonded to the nose piece 510 by way of the bonding agent 512. According to yet another alternative embodiment of the present disclosure, the magnet 514 is bonded both to the end surface 516 and to the nose piece 510 by way of the bonding agent 512.

A variation on the apparatus depicted in FIG. 8 includes a handle. The handle can be substantially solid. An end surface is defined on the handle. The end surface can be substantially concave. However, it is to be understood that the end surface can have any of a number of alternative shapes and/or contours according to the intended scope of the present disclosure. The apparatus includes a magnet which can be substantially identical, in configuration and/or function, to the magnet 214 described hereinabove with respect to FIG. 5. The apparatus includes a nose piece that can be similar to the nose piece 510 described hereinabove with respect to FIG. 8. More specifically, the handle of the apparatus includes a shoulder which is located below, but proximate to, the end surface of the handle. The nose piece is sized and configured to substantially rest on the shoulder of the handle. When mated to the shoulder, the nose piece captures the magnet into the space defined between the end surface and the inner surface of the nose piece. The nose piece can be secured to the shoulder of the handle by means such as welding (including thermal or ultrasonic welding when the nose piece and the handle are fabricated from materials such as plastic or other polymeric type materials), or by gluing. Further, when the nose piece is mated to the handle, the handle and the nose piece can form a substantially smooth and continuous outer surface of the apparatus.

In one embodiment of the apparatus the handle can be formed of a transparent material of a first color, and the nose piece can be formed of a transparent material of a second color. By providing transparent materials for the handle and the nose piece, the magnet can be readily seen by a user, thus facilitating the user in identifying the magnetic end of the apparatus. Further, by providing materials of different colors for the handle and the nose piece (e.g., green for the handle, and red for the nose piece), the user can more easily identify the end of the apparatus (i.e., the nose end) which contains the magnet.

The handle can include one or more indents which are located proximate the nose piece. (The indents can also define a continuous indent about the circumference of the handle.) The one or more indents can facilitate a user in placing his or her fingers on the apparatus proximate the magnet, such that the user will naturally understand which end of the apparatus is intended for use in picking up a hearing aid battery or the like.

The apparatus described herein above can be provided with one or more means to facilitate a user in easily and/or naturally grasping the apparatus in order to place the magnetic end of the apparatus (proximate the nose piece) in position for picking up a hearing aid battery or the like. That is, one or more of the following features, described above, can be incorporated into the apparatus 101, 201, 310, 401 and/or 501 in order to facilitate a user in easily and/or naturally grasping the apparatus in order to place the magnetic end of the apparatus (proximate the nose piece) in position for picking up a hearing aid battery or the like: (i) one or more indents located proximate the nose piece (e.g., 110, 210, 310, 410, 510) of the respective apparatus; (ii) a selected color for the nose piece (e.g., 110, 210, 310, 410, 510) which is distinctive from the color of the respective handle (e.g., 102, 202, 302, 402, 502), and more particularly, a color for the nose piece which is bright in contrast to the handle (e.g., colors of white, red, orange, yellow, and fluorescent colors for the nose piece, as contrasted to colors of black, green, blue, purple, and flat colors for the handle); and (iii) transparency of the handle and /or nose piece in the region of the magnet (e.g., 214, 314, 414, 514) in order to allow the user to see the magnet. These described features (which allow a user to easily and naturally identify the magnetic end of the apparatus) are particularly useful for users who are visually impaired.

### Kit Assembly Embodiment

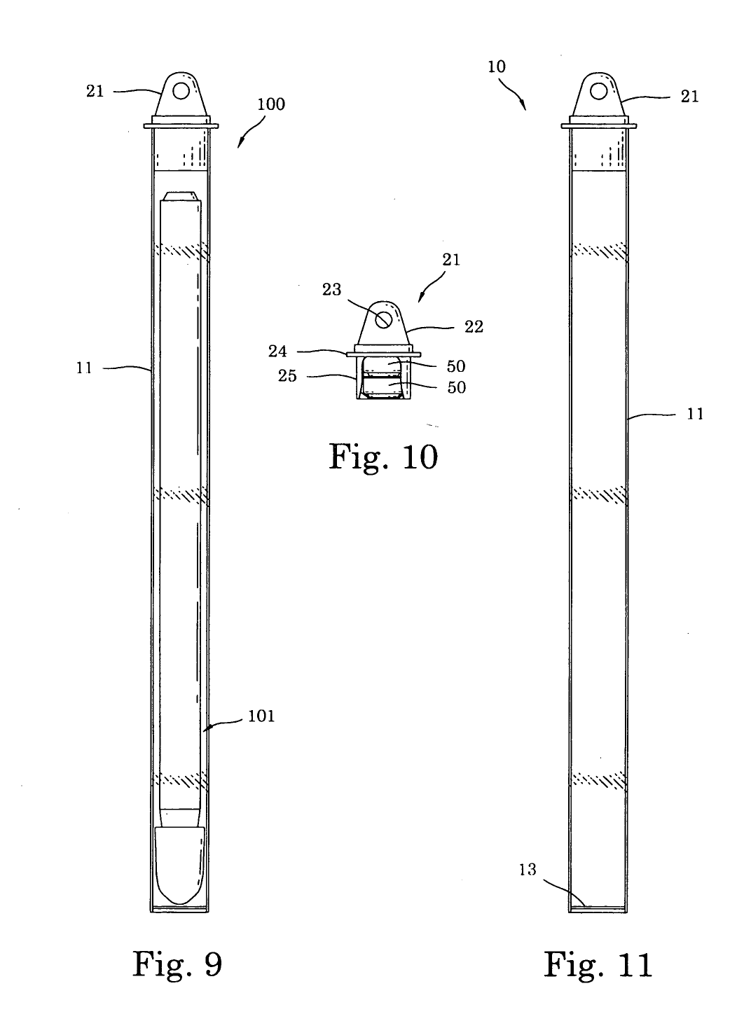

Turning now to FIG. 9, a side elevational view depicts a kit assembly 100 according to at least one embodiment of the present disclosure. The exemplary kit assembly 100 includes a container 11, a container top 21, and a handler apparatus 101. The handler apparatus 101, and various exemplary internal configurations thereof, are described herein above with respect to FIGS. 1-8. (That is, the handler apparatus can be the apparatus 101, 201, 301, 401, and/or 501.) The container top 21 is shown in FIG. 10, which is a side (elevational) cutaway view. The container 11 with the top installed is shown in FIG. 11, which is a side (elevational) view.

With reference to FIGS. 9-11, the container 11, together with the top 21, are adapted to contain the apparatus 101 (and variations thereof, as for example, apparatuses 201, 301, 401 and 501, described above). The container 11 and the top 21 can serve as protective packaging for the apparatus 101 (and variations thereof) during shipping of the apparatus 101 and/or during display of the apparatus at a retail sales establishment, for example. The container 11 and the top 21 can also serve to protect the apparatus 101 (and variations thereof) when it is carried and/or stored by an end user. The cap 21 can be adapted to store therein one or more batteries 50, as is depicted in the cutaway view of FIG. 10.

The container 11 can be substantially in the form of a tube with a closed end 13. The top 21 can be substantially in the form of a plug that fits snuggly within an open end of the container 11, which is substantially opposite the closed end 13. The container 11 can have one of a number of specific configurations and/or shapes. According to the exemplary embodiment of the disclosure, the container 11 is substantially in the form of an elongated, round, hollow cylinder. The exemplary container 11 is slightly larger than the apparatus 101 to provide a suitable fit as depicted in FIG. 9. Preferably, the size of the container 11 allows the apparatus 101 to be placed into, and retrieved from, the container with relative ease, while also minimizing movement of the apparatus relative to the container when the apparatus is contained therein. The container 11 can be substantially transparent, in order to allow the apparatus 101 to be viewed while the apparatus is within the container. For example, the container can be fabricated from a substantially clear plastic material. Alternatively, the container 11 can be fabricated from a translucent material, or from an opaque material.

Still referring to FIGS. 9-11, the top 21 is adapted to complement the container 11 in order to contain therewithin the apparatus 101. The top 21 is more specifically adapted for removable complementary engagement with an open end of the container 11, which end is substantially opposite and distal from the closed end 13 thereof. According to the exemplary embodiment of the disclosure, the top 21 is substantially in the form of a plug of which a portion is adapted for a snug slip fit with a portion of the container 11 in the manner depicted. Such a slip fit engagement of the top 21 and the container 11 will preferably result in sufficient friction therebetween to cause the top to remain in place by way of such friction alone during normal use of the container.

According to the exemplary embodiment of the present disclosure, the top 21 includes a barrel portion 25, a rim portion 24, and an outer portion 22. The barrel portion 25 is adapted to fit into the container 11 for frictional engagement therewith. Thus, according to at least one embodiment of the present disclosure, the barrel portion 25 is in the form of a round cylinder that is slightly smaller in diameter than that of the container 11, which is also in the form of a round cylinder. The barrel portion 25 can be adapted to house or otherwise support therein at least one battery 50, as shown in FIG. 10. According to the exemplary embodiment of the disclosure, the top 21 is adapted to contain therein one or more batteries 50 (two of which are depicted in juxtaposition in FIG. 10). In this manner, the top 21 can serve as a convenient place for storage of one or more batteries 50. The kit assembly 100 can be marketed as including therewith one or more batteries 50. Alternatively, the kit assembly 100 can be marketed without any batteries 50.

With continued reference to FIGS. 9-11, the rim portion 24 of the top 21 is adapted to serve as a stop to prevent the top from being pushed too far into the container 11. The rim portion 24 can also be adapted to serve as an aid in grasping the top for insertion into, and removal from, the container 11. According to the exemplary embodiment of the present disclosure, the rim portion 24 is substantially in the form of a round, flat, annular ring that circumscribes the barrel portion 25, and which is adjacent to the outer portion 22.

The outer portion 22 extends in a substantially axial direction from the barrel portion 25 and the rim portion 24, according to the exemplary embodiment of the disclosure. The outer portion 22 can be substantially in the form of a flat flange that extends substantially normally from the rim portion 24. The outer portion 23 can define therethrough an opening or hole 23. The opening 23 can serve to allow the container 11, by way of the top 21, to be hung from a hook on a display rack in a retail sales establishment, for example. That is, such a hook can be placed through the opening 23 to allow the kit assembly 100 to be supported on such a hook. The outer portion 22 can be adapted to serve as an aid in grasping the top 21 when the top is inserted into, or removed from, the container 11.

In one variation, the battery (or batteries 50) are placed within the receptacle formed by the barrel portion 25 of the top 21 in opposite orientation to that depicted in FIG. 10—i.e., with the positive battery pole (generally, the large diameter end of the battery 50) exposed so that the battery pick-up apparatus 101 can be used in the fashion depicted in FIG. 4 to remove the battery from the receptacle.

Methods

In accordance with one or more embodiments of the present disclosure, one or more methods for handling a hearing aid battery include selecting an apparatus having a handle, a nose piece attached to the handle and at least one magnet disposed between the nose piece and the handle. The method can include attracting the hearing aid battery using the nose piece end of the apparatus and holding the hearing aid battery against the nose piece. The battery can thus be moved into a suitable and desired location, followed by positioning the battery into a resting position. The resting position can include, for example, an installed position within a battery receptacle of a hearing aid or other electronic device. The apparatus can be moved to slideably remove the battery off of the nose piece and into a desired finishing position (e.g., within a battery receptacle).

I claim:

1. An apparatus for facilitating handling and use of hearing aid batteries, comprising:
a handle adapted for being gripped by a user of the apparatus, said handle having a first end portion;
a nose piece attached to the handle at the first end portion in a manner adapted to keep the nose piece attached thereto;
at least one magnet captured between the handle and the nose piece; and
wherein the nose piece and the at least one magnet are adapted so the nose piece moderates magnetic attraction of a hearing aid battery to the at least one magnet and provides contact of a hearing aid battery to the nose piece with moderated forces as compared to direct contact by said at least one magnet with the hearing aid battery, thus facilitating handling of hearing aid batteries by the apparatus.

2. An apparatus according to claim 1 wherein the nose piece is securely attached to the handle.

3. An apparatus according to claim 1 wherein the nose piece is made of material which is magnetically permeable.

4. An apparatus according to claim 1 wherein the nose piece is made of a polymer material which is configured to attenuate the magnetic attraction of the hearing aid battery to the magnet such that the hearing aid battery can be removed from the nose piece by wiping the nose piece across an opening of a hearing aid battery receptable configured within the hearing aid.

5. An apparatus according to claim 4 wherein the nose piece is made of one of a polyvinyl polymer or an ABS polymer.

6. An apparatus according to claim 1 wherein the nose piece is provided with apertures therein to allow magnetic flux therethrough.

8. An apparatus according to claim 1 wherein the handle is made of a ABS polymer.

9. An apparatus according to claim 1 wherein the nose piece and the handle are made of a polymer, and the nose piece and handle are adhered together.

10. An apparatus according to claim 1 wherein the nose piece is adhered to the handle.

11. An apparatus according to claim 1 wherein the nose piece has at least one contact area adapted for engaging with a hearing aid battery at a desired orientation when such a battery is attracted to the nose piece by said at least one magnet.

12. An apparatus according to claim 11 wherein the nose piece is defined by an exposed end and a side portion, and the magnet is positioned beneath the nose piece such that the hearing aid battery attaches to the nose piece in an area defined between the exposed end and the side portion of the nose piece.

13. An apparatus for facilitating handling and use of hearing aid batteries, comprising:
a handle adapted for being gripped by a user of the apparatus, said handle having a first end portion;
a nose piece attached to the handle at the first end portion in a manner adapted to keep the nose piece attached thereto;
at least one magnet captured between the handle and nose piece;
a container for receiving the handle, nose piece and at least one magnet as an assembly;
wherein the nose piece and the at least one magnet are adapted so the nose piece moderates the magnetic attraction of a hearing aid battery and provides contact of a hearing aid battery by the nose piece with moderated forces as compared to direct contact by said at least one magnet and thus facilitate handling of hearing aid batteries by the apparatus.

14. An apparatus according to claim 13 wherein the nose piece is securely attached to the handle.

17. An apparatus according to claim 13 wherein the nose piece is made of material which is magnetically permeable.

18. An apparatus according to claim 13 wherein the nose piece is made of material which is a polymer.

19. An apparatus according to claim 13 wherein the nose piece is provided with apertures therein to allow magnetic flux therethrough.

20. An apparatus according to claim 13 wherein the nose piece is made of material which is a polymer.

21. An apparatus according to claim 13 wherein the nose piece is adhered to the handle.

22. An apparatus according to claim 13 wherein the nose piece has at least one contact area adapted for engaging with a hearing aid battery at a desired orientation when such a battery is attracted to the nose piece by said at least one magnet.

23. A method for handling a hearing aid battery, comprising:
selecting an apparatus having a handle, a nose piece attached to the handle and at least one magnet captured between the nose piece and handle;
attracting the hearing aid battery using the nose piece end of the apparatus and holding the hearing aid battery against the nose piece;
moving the hearing aid battery attracted to the nose piece into a suitable and desired location;
positioning the hearing aid battery into a resting position;
moving the apparatus to slide the hearing aid battery off the nose piece and into the desired finishing position.
